(19) United States
(12) Patent Application Publication
(10) Pub. No.: US 2013/0003698 A1
(43) Pub. Date: Jan. 3, 2013

(54) METHOD AND APPARATUS FOR MANAGING SERVICE CONTINUITY

(75) Inventors: Ulises Olvera-Hernandez, Kirkland (CA); Mahmoud Watfa, St . Leonard (CA); Saad Ahmad, Montreal (CA)

(73) Assignee: INTERDIGITAL PATENT HOLDINGS, INC., Wilmington, DE (US)

(21) Appl. No.: 13/537,886

(22) Filed: Jun. 29, 2012

Related U.S. Application Data
(60) Provisional application No. 61/503,766, filed on Jul. 1, 2011.
(60) Provisional application No. 61/513,007, filed on Jul. 29, 2011.

(51) Int. Cl. H04W 48/08; H04W 4/22; H04W 68/00; H04W 36/00

(52) U.S. Cl. 370/331; 370/328

(57) ABSTRACT

Methods and apparatus are disclosed that determine whether service continuity is allowed in a target cell for a wireless transmit/receive unit (WTRU) connected to a source local gateway (LGW) via a local internet protocol access (LIPA) Packet Data Network (PDN) connection. The existence of a connection between the source LGW and a target LGW is also determined. Whether the WTRU user settings allow service continuity is determined. On a condition that service continuity is not allowed for the target LGW or for the WTRU, the LIPA PDN connection is deactivated. On a condition that service continuity is allowed for the target network and for the WTRU, the LIPA PDN connection is maintained. Methods for handling handover, paging and emergency calls are also described herein.

### CROSS REFERENCE TO RELATED APPLICATIONS

This application claims the benefit of U.S. provisional application No. 61/503,766, filed Jul. 1, 2011, and U.S. provisional application No. 61/513,007, filed Jul. 29, 2011, the contents of which are hereby incorporated by reference herein.

### FIELD OF THE INVENTION

This application is related to wireless communications.

### BACKGROUND

Local Internet Protocol (IP) access (LIPA) may be used to provide an IP connection to a local network using the radio access of a home Node-B (HNB) or a home evolved Node-B (HeNB) (collectively HeNB). Access to a local IP network is achieved by the use of a Local Gateway (LGW), which may be collocated with the HeNB.

If a wireless transmit/receive unit (WTRU) moves out of the HeNB coverage area, (either in idle or connected mode), the LIPA connection may be deactivated. For a WTRU in connected mode and about to perform handover (HO) to another cell, the HeNB has to first inform the LGW about the HO so that the latter deactivates the LIPA packet data network (PDN) connection, (this signaling is done towards the mobility management gateway (MME)). The WTRU may be handed over to another cell after the LIPA PDN connection has been deactivated. During the HO, if the MME sees that the LIPA bearer/PDN connection was not deactivated, then the MME rejects the HO. If a WTRU moves out of the HeNB subsystem altogether, (i.e., moves out of the coverage area of all the HeNBs that connect to the LGW), then the WTRU's LIPA PDN connection may be deactivated.

Selected IP Traffic Offload (SIPTO) is a process in which a network operator chooses a PDN gateway (PGW) to offload traffic to the Internet. The WTRU's physical location or IP topological location makes it favorable to select a PGW different from the core network's (CN) PGW. SIPTO may be achieved above the radio access network (RAN) and regardless of whether the radio connection of the WTRU is obtained via an eNB or an HeNB. The selection of another PGW might not be known to the WTRU, and the offload of the WTRU's traffic to a LGW might degrade the user's service experience.

### SUMMARY

Methods and apparatus are disclosed that determine whether service continuity is allowed in a target cell for a wireless transmit/receive unit (WTRU) connected to a source local gateway (LGW) via a local internet protocol access (LIPA) Packet Data Network (PDN) connection. The existence of a connection between the source LGW and a target LGW is also determined. Whether the WTRU user settings allow service continuity is determined. On a condition that service continuity is not allowed for the target LGW or for the WTRU, the LIPA PDN connection is deactivated. On a condition that service continuity is allowed for the target network and for the WTRU, the LIPA PDN connection is maintained. Methods for handling handover, paging and emergency calls are also described herein.

### BRIEF DESCRIPTION OF THE DRAWINGS

A more detailed understanding may be had from the following description, given by way of example in conjunction with the accompanying drawings wherein:

FIG. 1A shows an example communications system in which one or more described embodiments may be implemented;

FIG. 1B shows an example wireless transmit/receive unit (WTRU) that may be used within the communications system shown in FIG. 1A;

FIG. 1C shows an example radio access network and an example core network (CN) that may be used within the communications system shown in FIG. 1A;

FIG. 2 shows an example system for accessing a local IP network through a local gateway (LGW);

FIG. 3 shows an example standalone LGW architecture for multiple home evolved Node-B (HeNBs);

FIG. 4 shows another example standalone LGW architecture for multiple HeNBs;

FIG. 5 shows an example of a selected IP traffic offload (SIPTO) service in which a network operator chooses a packet data network gateway (PGW) to offload traffic;

FIG. 6 shows an example offload of user data to the Internet via an LGW that is on the HeNB subsystem;

FIG. 7 shows an example standalone LGW architecture in an HeNB subsystem for an evolved packet system (EPS);

FIG. 8 shows an example standalone LGW architecture in an home node B (HNB) subsystem for evolved packet system (EPS);

FIG. 9 shows an example standalone LGW architecture for universal mobile telecommunications system (UMTS);

FIG. 10 shows an example standalone LGW on the S1 path in an HeNB subsystem for EPS;

FIG. 11 shows an example standalone LGW on the Iuh path in an HNB subsystem for EPS;

FIG. 12 shows an example standalone LGW on the Iuh path in an HNB subsystem for UMTS;

FIG. 13 shows an example system and flow of a user starting a managed remote access (MRA) session in an HeNB that is not part of a local network (LN) and then hands off to an HeNB that is part of the LN;

FIG. 14 shows an example system and flow of a user starting a Local Internet Protocol (IP) access (LIPA) session in a local network and moving to a macro network coverage area in which the LIPA session continues as a MRA session;

FIG. 15 shows an example signaling flow for a network initiated dedicated bearer activation procedure;

FIG. 16 shows an example of a WTRU moving from one closed subscriber group to another;

FIG. 17 shows an example of idle mode mobility from one LN to another; and

FIG. 18 shows a LIPA session continued as a MRA session as users move between an HeNB where LIPA is allowed and an HeNB where LIPA is not allowed, in the same local network.

### DETAILED DESCRIPTION

When referred to hereinafter, the terminology “HeNB” and “HNB” will be used interchangeably, and reference to either of them will represent both HeNB and HNB unless otherwise noted.

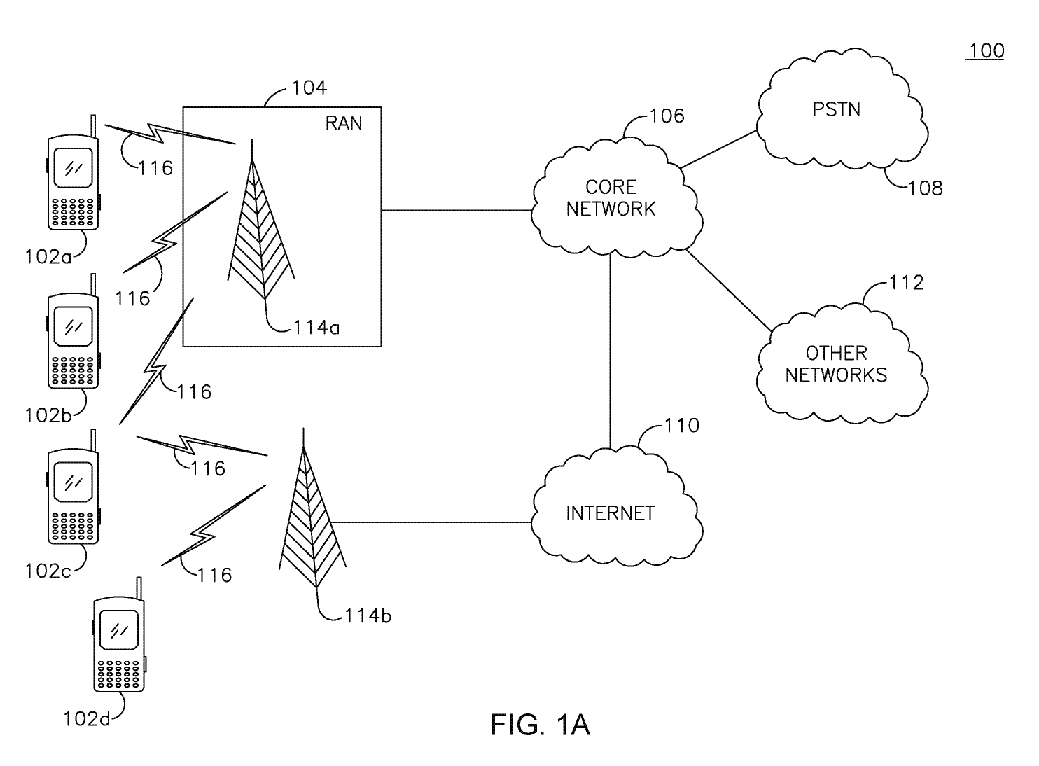

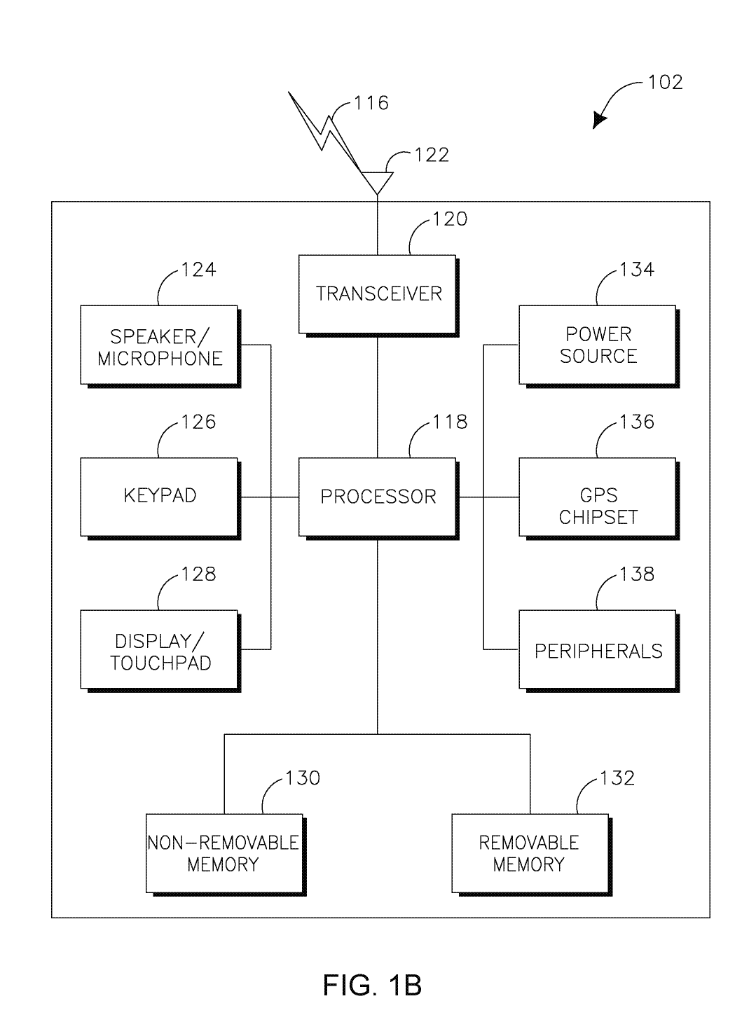

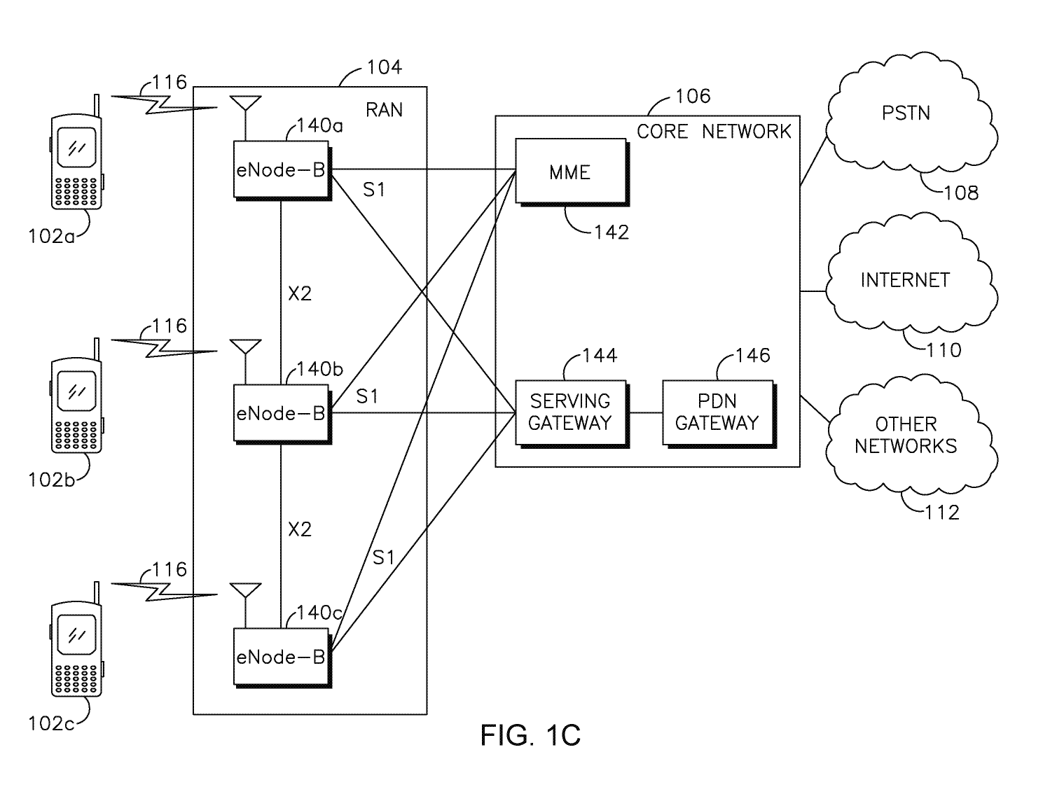

FIG. 1A shows an example communications system 100 in which one or more described embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, 102d, a radio access network (RAN) 104, a core network (CN) 106, a public switched telephone network (PSTN) 108, the Internet 110, and other networks 112, though it will be appreciated that the described embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a notebook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an evolved Node-B (eNB), a Home Node-B (HNB), a Home eNB (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, and the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink (DL) packet access (HSDPA) and/or high-speed uplink (UL) packet access (HSUPA).

In another embodiment, the base station 114a and the WTRUs 102a, 102b, 102c may implement a radio technology such as evolved UTRA (E-UTRA), which may establish the air interface 116 using long term evolution (LTE) and/or LTE-Advanced (LTE-A).

In other embodiments, the base station 114a and the WTRUs 102a, 102b, 102c may implement radio technologies such as IEEE 802.16, (i.e., worldwide interoperability for microwave access (WiMAX)), CDMA2000, CDMA2000 1X, CDMA2000 evolution-data optimized (EV-DO), Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), and the like.

The base station 114b in FIG. 1A may be a wireless router, HNB, HeNB, or AP, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT, (e.g., WCDMA, CDMA2000, GSM, LTE, LTE-A, and the like), to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over Internet Protocol (VoIP) services to one or more of the WTRUs 102a, 102b, 102c, 102d. For example, the CN 106 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an E-UTRA radio technology, the CN 106 may also be in communication with another RAN (not shown) employing a GSM radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet Protocol (IP) in the TCP/IP suite. The networks 112 may include wired or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B shows an example WTRU 102 that may be used within the communications system 100 shown in FIG. 1A. As shown in FIG. 1B, the WTRU 102 may include a processor 118, a transceiver 120, a transmit/receive element, (e.g., an antenna), 122, a speaker/microphone 124, a keypad 126, a display/touchpad 128, a non-removable memory 130, a removable memory 132, a power source 134, a global positioning system (GPS) chipset 136, and peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a microprocessor, one or more microprocessors in association with a DSP core, a controller, a microcontroller, an application specific integrated circuit (ASIC), a field programmable gate array (FPGA) circuit, an integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122, (e.g., multiple antennas), for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station, (e.g., base stations 114a, 114b), and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example CN 106 that may be used within the communications system 100 shown in FIG. 1A. As noted above, the RAN 104 may employ an E-UTRA radio technology to communicate with the WTRUs 102a, 102b, 102c over the air interface 116. The RAN 104 may also be in communication with the CN 106.

The RAN 104 may include eNBs 140a, 140b, 140c, though it will be appreciated that the RAN 104 may include any number of eNBs while remaining consistent with an embodiment. The eNBs 140a, 140b, 140c may each include one or more transceivers for communicating with the WTRUs 102a, 102b, 102c over the air interface 116. In one embodiment, the eNBs 140a, 140b, 140c may implement MIMO technology. Thus, the eNB 140a, for example, may use multiple antennas to transmit wireless signals to, and receive wireless signals from, the WTRU 102a.

Each of the eNBs 140a, 140b, 140c may be associated with a particular cell (not shown) and may be configured to handle radio resource management decisions, handover decisions, scheduling of users in the UL and/or DL, and the like. As shown in FIG. 1C, the eNBs 140a, 140b, 140c may communicate with one another over an X2 interface.

The CN 106 shown in FIG. 1C may include a mobility management entity (MME) 142, a serving gateway 144, and a packet data network (PDN) gateway (GW) 146. While each of the foregoing elements is depicted as part of the CN 106, it will be appreciated that any one of these elements may be owned and/or operated by an entity other than the CN operator. Network nodes are configured to receive, and transmit information in any manner including, including but not limited to, wired and wireless technologies.

The MME 142 may be connected to each of the eNBs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway (SGW) 144 may be connected to each of the eNBs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNB handovers, triggering paging when DL data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway, (e.g., an IP multimedia subsystem (IMS) server), that serves as an interface between the CN 106 and the PSTN 108. In addition, the CN 106 may provide the WTRUs 102a, 102b, 102c with access to other networks 112, which may include other wired or wireless networks that are owned and/or operated by other service providers.

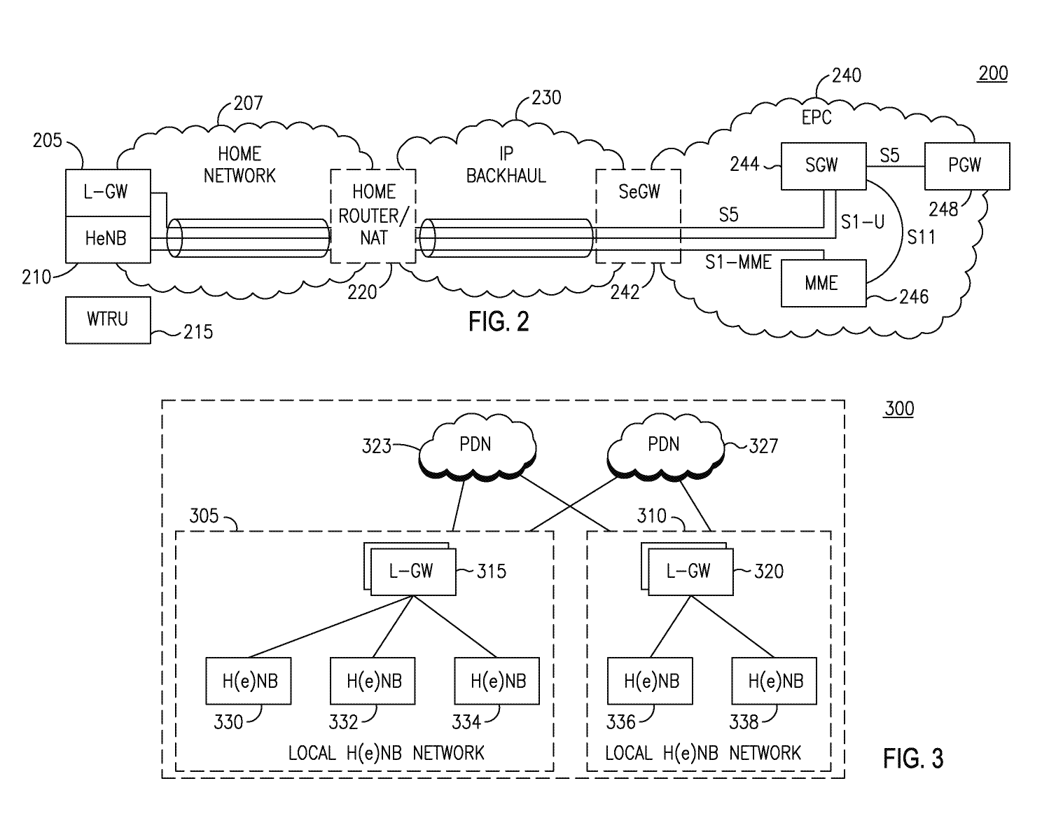

Local IP access (LIPA) may provide an IP connection to a local network using the radio access of an HeNB. FIG. 2 shows an example system 200 for accessing a local IP network through a local gateway (LGW) 205, which may be collocated on an HeNB 210. The local IP network may be, for example, a home network 207. The local gateway (LGW) 205 may have functions similar to, for example, a packet data network (PDN) gateway (PGW), (for example, a general packet radio service (GPRS) support node (GGSN)).

The system 200 may include an evolved packet core (EPC) 240, which may include, but is not limited to, a security gateway (SeGW) 242, a serving gateway (SGW) 244, a mobility management entity (MME) 246, and a packet data network gateway (PGW) 248. The LGW 205 and HeNB 210 may be in communication with the SeGW 242 through an IP backhaul 230 using a home router/network address translator (NAT) 220. In particular, the LGW 205 and HeNB 210 may be in communication with the SGW 244 and the HeNB may also be in communication with the MME 246, all via the SeGW 242.

As stated herein above, the LGW 205 may be collocated with the HeNB 210. Therefore, if a WTRU 215 moves out of the coverage area of the HeNB 210, (either in an idle mode or connected mode), the LIPA PDN connection may be deactivated. Moreover, for a WTRU 215 in a connected mode and about to perform handover (HO) to another cell, the HeNB 210 may first inform the LGW 205 about the HO, so that the LGW 205 may deactivate the LIPA PDN connection, (this signaling may be sent to the MME 246). After the LIPA PDN connection is deactivated, the WTRU 215 may be handed over to another cell. During the HO, if the MME 246 detects that the LIPA bearer/PDN connection was not deactivated, then the MME 246 may reject the HO.

FIG. 3 shows an example standalone LGW architecture 300 for multiple home evolved Node-B (HeNBs), which allows for continuity of a LIPA PDN connection as the WTRU moves between HeNBs. Multiple HeNBs that connect to the same LGW may be referred to as an HeNB subsystem. In this instance, standalone LGW architecture 300 may include a local HeNB network 305 and a local HeNB network 310, each in communication with a PDN 323 and a PDN 327. The local HeNB network 305 may include an LGW 310 which may be in communication with HeNBs 330, 332 and 334 and the local HeNB network 310 may include an LGW 327 which may be in communication with HeNBs 336 and 338. As shown, LGW 310 and 315 are standalone entities in that they are not collocated on a single HeNB. A WTRU (not shown) with a LIPA PDN connection to an HeNB subsystem may move across all connected HeNBs while maintaining the LIPA PDN connection. If a WTRU moves out of the HeNB subsystem altogether, (i.e., moves out of the coverage of all the HeNBs that connect to an LGW), then the WTRU's PDN connection for LIPA may be deactivated.

If a WTRU moves out of the coverage of the HeNB, for example HeNBs 330, 332, 334, 336 or 338, (either in idle or connected mode), the LIPA PDN connection may be deactivated. For a WTRU in connected mode and about to perform handover (HO) to another cell, the LIPA PDN connection may not be deactivated for every HO. For example, if the WTRU is a member of each HeNB 330, 332, 334, 336 or 338, as the WTRU moves across the HeNBs 330, 332, 334, 336 or 338, the LIPA session may be maintained and the data path switched towards the new HeNB from the LGW. As long at the new HeNB connects to the LGW and the WTRU is a member of the HeNB and LIPA is allowed in the HeNB, then the WTRU may maintain the LIPA session as it moves around.

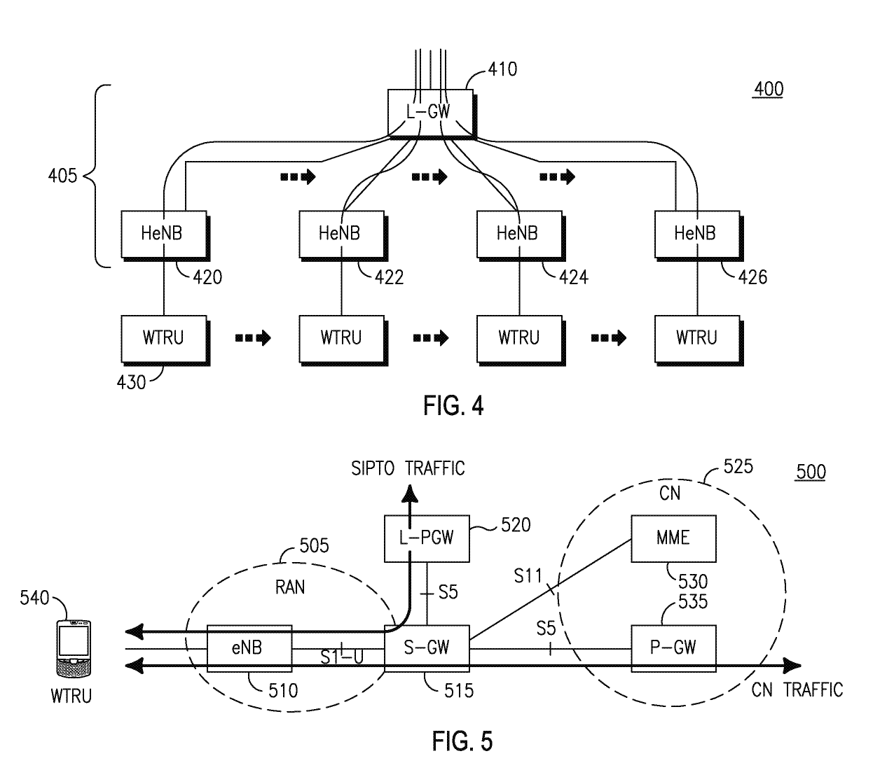

FIG. 4 shows another example standalone LGW architecture 400 for multiple home evolved Node-B (HeNBs), which allows for continuity of a LIPA PDN connection as the WTRU moves between HeNBs. As stated above, multiple HeNBs that connect to the same LGW may be referred to as an HeNB subsystem. In this instance, standalone LGW architecture 400 may include a local HeNB network 405 which may include an LGW 410 in communication with HeNBs 420, 422, 424 and 426. As shown, LGW 410 is a standalone entity that is not collocated on a single HeNB. A WTRU 430 with a LIPA PDN connection to HeNB subsystem 405 may move across all connected HeNBs 420, 422, 424 and 426 while maintaining the LIPA PDN connection. If a WTRU moves out of the HeNB subsystem 405 altogether, (i.e., moves out of the coverage of all the HeNBs 420, 422, 424 and 426 that connect to LGW 410), then the WTRU's 430 PDN connection for LIPA may be deactivated.

FIG. 5 shows an example of a wireless communications system 500 using a selected IP traffic offload (SIPTO) service, where a network operator may choose a PGW to offload traffic to the Internet. In particular, a WTRU's physical location or IP topological location may make it favorable to select a PGW different from the core network (CN) PGW. The wireless communications system 500 may include a radio access network (RAN) 505 as provided by a eNB 510 in communication with a SGW 515. The SGW 515 may, in turn, be in communications with a local PGW 520 (L-PGW, or also known as LGW), and a CN 525 that may include a MME 530 and a PGW 535. A WTRU 540 may use the SIPTO connection to offload user data to the Internet (not shown) via the LGW 520. SIPTO may be achieved above the RAN, and regardless of whether the radio connection of a WTRU is obtained via an eNB or an HeNB. The selection of another PGW may not be known to the WTRU, and the offload of the WTRU's traffic to the LGW may degrade the user's service experience.

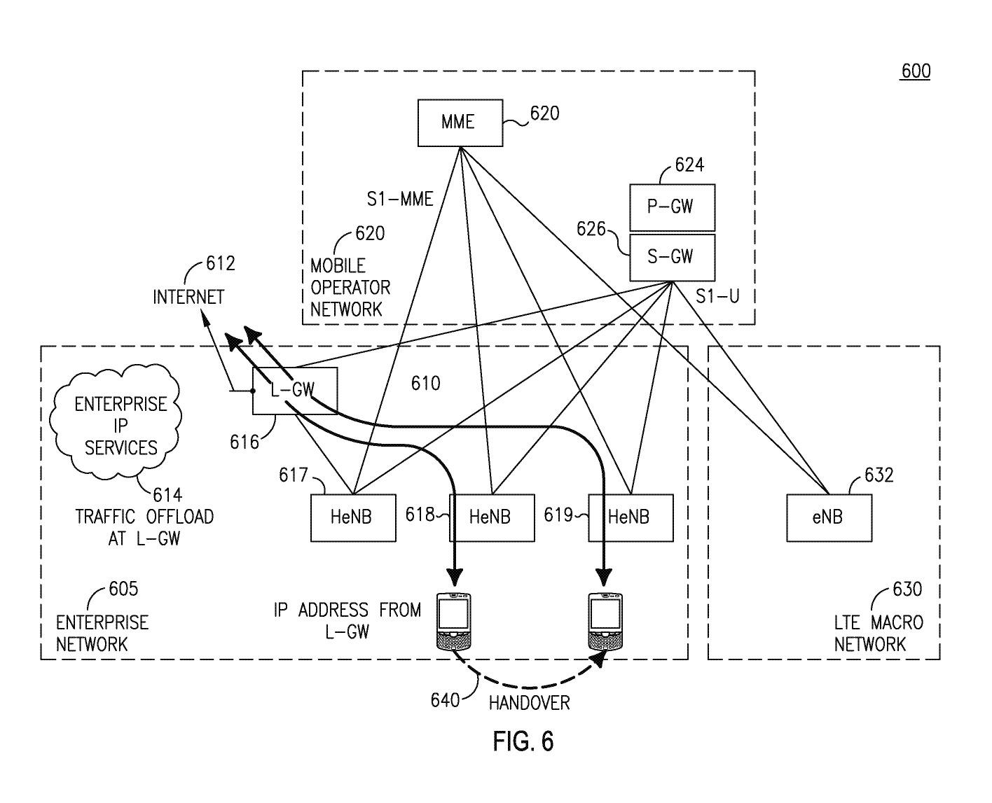

FIG. 6 shows example architecture 600 for offload of user data to the Internet via an LGW that is on an HeNB subsystem. An enterprise network 605, (i.e., a local network), may include an HeNB subsystem 610 that is connected to the Internet 612 via enterprise IP services 614. The HeNB subsystem 610 may include a LGW 616 that may be in communication with HeNB 617, HeNB 618 and HeNB 619. A mobile operator network (MNO) 620 may include a MME 622, a PGW 624 and SGW 626. A LTE macro network 630 may include an eNB 632, which may be in communication with the MME 622 and SGW 626. The MME 622 and SGW 626 may both be in communication with HeNB 617, HeNB 618 and HeNB 619 and the SGW 626 may also be in communication with LGW 616. A WTRU 640 may be in communication with HeNB 618 or 619 as a result of a handover. In this architecture 600, both LIPA and SIPTO may be possible, (i.e., the LGW 616 may be used to access a local IP network (i.e., LIPA)), while also being able to offload a WTRU's 640 data to the Internet 612 via the same LGW 616.

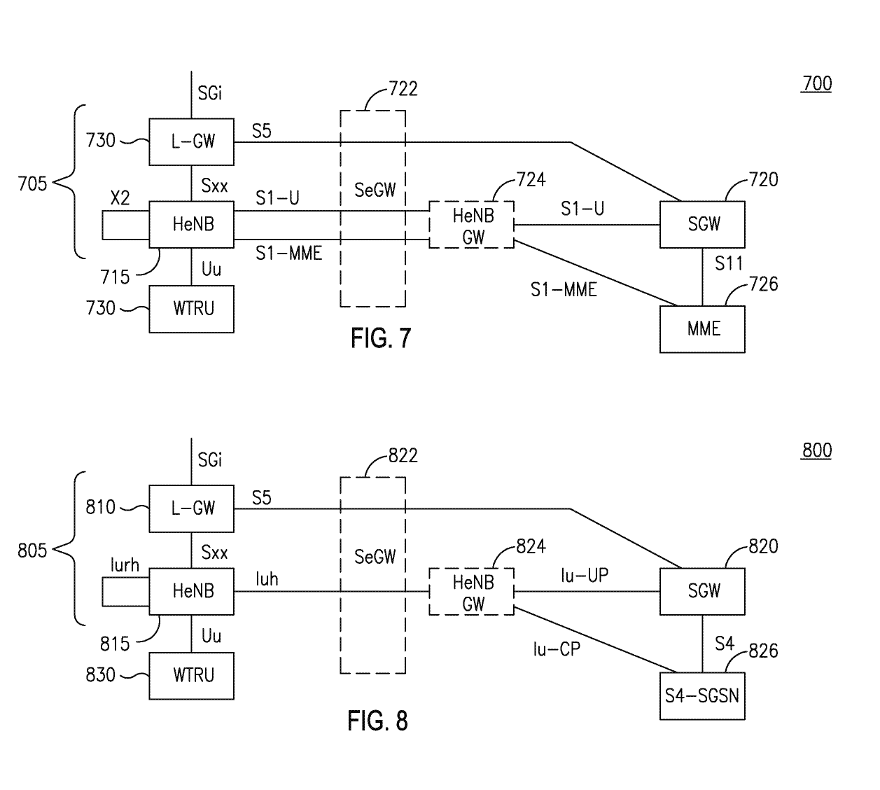

FIG. 7 shows example standalone LGW architecture 700 for evolved packet system (EPS). The LGW architecture 700 may include an HeNB subsystem 705 that may include a LGW 710 in communication with an HeNB 715. The LGW 710 may be in communication with a SGW 720 via a SeGW 722. The HeNB 715 may be in communication with the SGW 720 and a MME 726 via the SeGW 722 and an HeNB gateway (GW) 724. A WTRU 730 may be in communication with the HeNB 715.

FIG. 8 shows example standalone LGW architecture 800 for EPS. The LGW architecture 800 may include an HNB subsystem 805 that may include a LGW 810 in communication with an HNB 815. The LGW 810 may be in communication with a SGW 820 via a SeGW 822. The HNB 815 may be in communication with the SGW 820 and a S4-Serving GPRS Support Node (SGSN) 826 via the SeGW 822 and an HNB GW 824. A WTRU 830 may be in communication with the HNB 815.

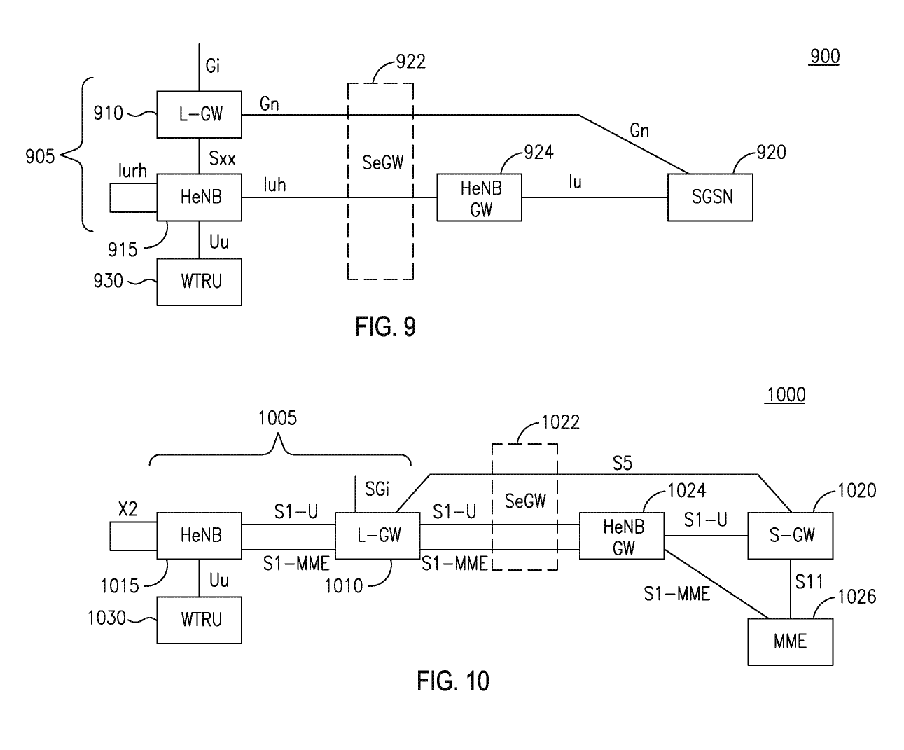

FIG. 9 shows example standalone LGW architecture 900 for universal mobile telecommunication system (UMTS). The LGW architecture 900 may include an HNB subsystem 905 that may include a LGW 910 in communication with an HNB 915. The LGW 910 may be in communication with a SGSN 920 via a SeGW 922. The HNB 915 may be in communication with the SGSN 920 via the SeGW 922 and an HNB GW 924. A WTRU 930 may be in communication with the HNB 915.

FIG. 10 shows example standalone LGW architecture 1000 on an S1/Iu path in an HeNB subsystem for EPS. The LGW architecture 1000 may include an HeNB subsystem 1005 that may include a LGW 1010 in communication with an HeNB 1015. The LGW 1010 may be in communication with a SGW 1020 and a MME 1026 via a SeGW 1022 and an HeNB GW 1024. A WTRU 1030 may be in communication with the HeNB 1015.

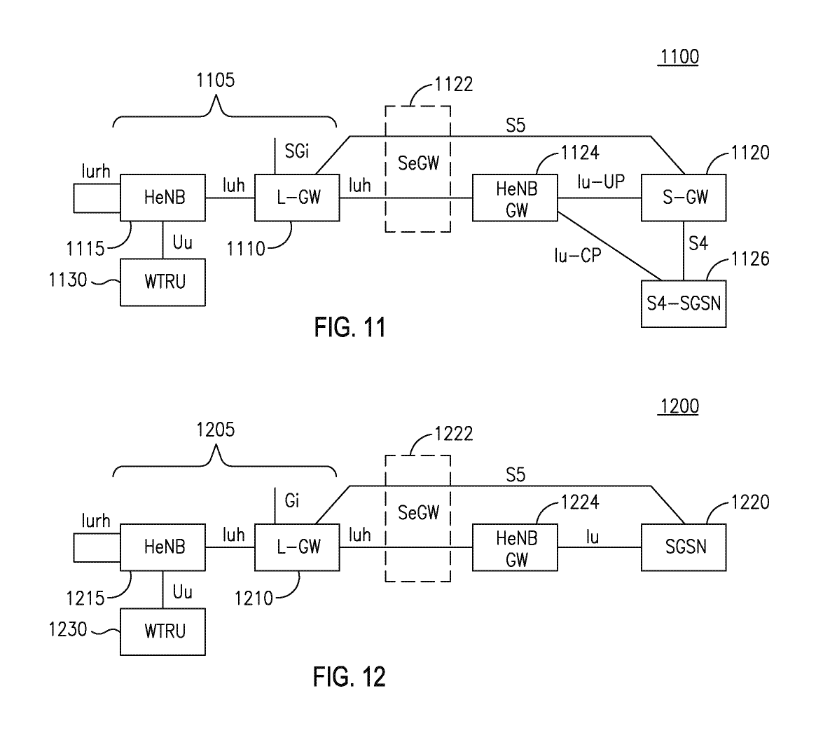

FIG. 11 shows example standalone LGW architecture 1100 on an Iuh path in an HNB subsystem for EPS. The LGW architecture 1105 may include an HNB subsystem 1105 that may include a LGW 1110 in communication with an HNB 1115. The LGW 1110 may be in communication with a SGW 1120 and a S4-SGSN 1126 via a SeGW 1122 and an HNB GW 1124. A WTRU 1130 may be in communication with the HNB 1115.

FIG. 12 shows example standalone LGW architecture 1200 on an Iuh path in an HNB subsystem for UMTS. The LGW architecture 1200 may include an HNB subsystem 1205 that may include a LGW 1210 in communication with an HNB 1215. The LGW 1210 may be in communication with a SGSN 1220 via a SeGW 1222 and also via the SeGW 1222 and an HNB GW 1224. A WTRU 1230 may be in communication with the HNB 1215.

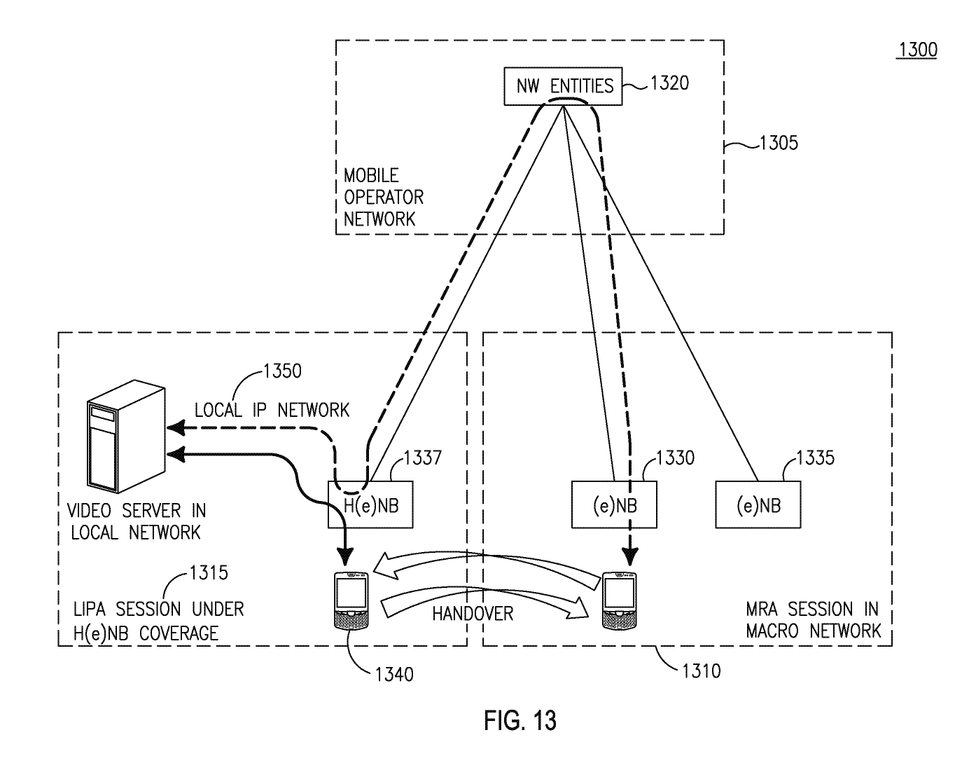

Continuity of data sessions may be desired as users move between a local network and a network that is not part of or connected to the local network. FIG. 13 illustrates an example architecture 1300 that may include a mobile operator core network 1305, a macro network 1310 and an HeNB subsystem 1315. The mobile operator core network 1305 may include network (NW) entities 1320, the macro network 1310 may include eNB 1330 and 1335 and the HeNB network 1315 may include an HeNB 1337. A WTRU 1340 may connect to a local network 1350 via the macro network 1310, (i.e. a macro cell, or an HeNB that is not part of a local network). This is referred to as a managed remote access (MRA) or remote IP access (RIPA). That is, a MRA session is when the actual cell, (macro or HeNB), does not connect to the local network. When the WTRU 1340 moves into the coverage area of the local network 1350, the MRA session may then be continued as a LIPA session. The opposite may be possible as well. The WTRU 1340 may start as a LIPA session in the local network 1350, and then move to the macro network 1310, where the LIPA session is continued as an MRA session. That is, a WTRU with a LIPA session may move to an HeNB that is not part of the local network.

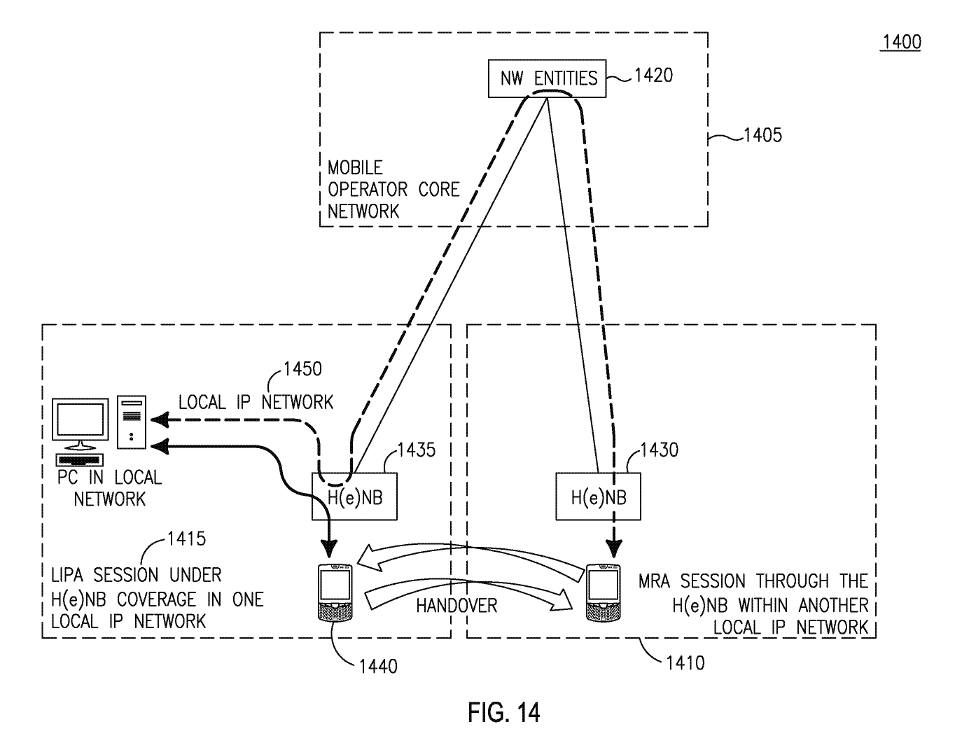

FIG. 14 illustrates an example architecture 1400 that may include a mobile operator core network 1405, an HeNB network 1410 and an HeNB subsystem 1415. The mobile operator core network 1405 may include network (NW) entities 1420, the HeNB network 1410 may include HeNB 1430 and the HeNB network 1415 may include an HeNB 1435. The WTRU 1440 may have an MRA session using HeNB 1430 that does not connect to the local network 1450. When the WTRU 1440 moves into the local network's 1450 coverage and hands off to the HeNB 1435 that is part of the local network 1450, the MRA session is continued as a LIPA session. The examples related to LIPA above may also be applied to SIPTO.

Although the examples given above are related to LIPA, the same may apply to SIPTO. For example a SIPTO at a local network (SIPTO@LN) may occur within a local network, or via macro coverage or an HeNB that is not part of the local coverage, as a MRA session. What has not been considered so far is the case when a WTRU still remains within the local network, (i.e. connects to an HeNB that is part of the local network), but the WTRU is not allowed to have LIPA service from a particular closed subscriber group (CSG) due to subscription information, for example.

Mobility management procedures, (registrations such as tracking/routing/location area updates), and session management procedures, (activation of PDN connections, modification and deactivation of PDN connections) are described herein.

Given the existing architectural solutions and others that might be defined later, the deactivation of LIPA and/or SIPTO PDN connections might be different under different architectures. For example, how to deactivate a LIPA PDN connection when there is no LGW to LGW connection might be different from the case where there is such a connection. In addition, the deactivation might be triggered by mobility management procedures, (for example, registration messages that are initiated from idle mode which might reflect that a WTRU has moved out of the coverage of a LIPA area while in idle mode), or handover procedures. Thus, the impacts of mobility management procedures, idle mode mobility, and handovers, under the different architectural solutions are described herein to make sure the service requirements for LIPA and SIPTO may be achieved.

An example architecture may have an HeNB GW deployed, and another may have the HeNB GW before the LGW. Other example architectures may have some of the core network functions, (for example, the HeNB-GW or HNB-GW functions, MME or SGSN/MSC functions), in the LGW or may have some of the core network node, (for example the HeNB GW or HNB GW), co-located with the LGW. In another architecture, the LGW may have an HeNB aggregator or HNB aggregator function, (i.e., enterprise gateway (EGW)), for presenting itself to the rest of the network, (local network, radio access network and core network), as a single node with multiple co-located cells or distant cells.

Other architectures and associated service access procedures or mobility procedures are not optimized to take advantage of potential close proximity between the HeNB-GW and the HeNBs or between HeNBs and non-collocated LGWs which may encompass some core network functions. In an enterprise deployment scenario for example, each employee desk or office is expected to have its own individual HeNB leading to potentially several hundreds or thousands of HeNBs connected individually to the operator core network or via the LGW and/or HeNB-GW through interfaces not designed to take full advantage of femtocell clustering or aggregation. This creates many challenges in terms of dealing with the increase of signaling loads on the operator core network. This may be reflected in the explosion of the core network interfaces into the RAN and in dealing with the provisioning and management of these many RAN nodes and associated interfaces directly under the care and control of the operator.

Moreover, if the HeNB-GW is co-located with the LGW, and/or some of the core network functions are implemented in the LGW, it is not clear what will be the split of security responsibility between the local network domain and the core network domain. For example, considering the tunnels from the enterprise network to the LGW and/or HeNB-GW and from these GWs to the distant operator core network cloud, there is a question of whether the operator delegates part of the control responsibility of securing these tunnels to the enterprise or femto network host. Implementation and impact on the current session management, mobility management, local network node, (HNB, HeNB, L-GW) registration procedures, and security keys management and distribution for securing the over-the-air transmission are addressed herein.

In some cases, a WTRU with a LIPA PDN connection might be in idle mode when a trigger to perform a registration occurs, a periodic tracking area update (TAU), for example. Moreover, the WTRU might be in the cell(s) that provide a LIPA PDN connection, (i.e. the HeNB(s) connect(s) to the LGW and LIPA service may be provided from the WTRU's location on a cell level). During this time, the WTRU may only need signaling radio bearers (SRBs) to perform a TAU procedure and a user plane for LIPA PDN connections and any other PDN connections might not be established. However, before the TAU procedure is completed with the CN, (for example the MME), the WTRU might hand over from one HeNB to another, (the HeNB performs SRB-only HO), and the MME might only be aware of the mobility after the HO is completed. Since the WTRU is now in a different cell, the response to the TAU from the MME might need to be changed to take into account the WTRU's location and therefore whether or not the LIPA PDN connection may still be maintained. Note that this might only be an issue in UTRAN where SRB-only HO may occur. Thus, for this case, as stated earlier, the response from the MME to the WTRU might need to be different given the WTRU's new cell location.

A WTRU may only be allowed to have a default EPS bearer for a LIPA PDN connection, i.e. dedicated bearers were not allowed to be setup within a LIPA PDN connection. In addition, there was no SIPTO at the local network (SIPTO@LN), thus for LIPA and SIPTO there were no network initiated session management procedures. For example, no network initiated dedicated EPS bearer setup. Hence, given that there is SIPTO@LN or given that there might be no limitations on the dedicated EPS bearer for LIPA, the network initiated session management procedures need to be analyzed to take into account LIPA and SIPTO@LN.

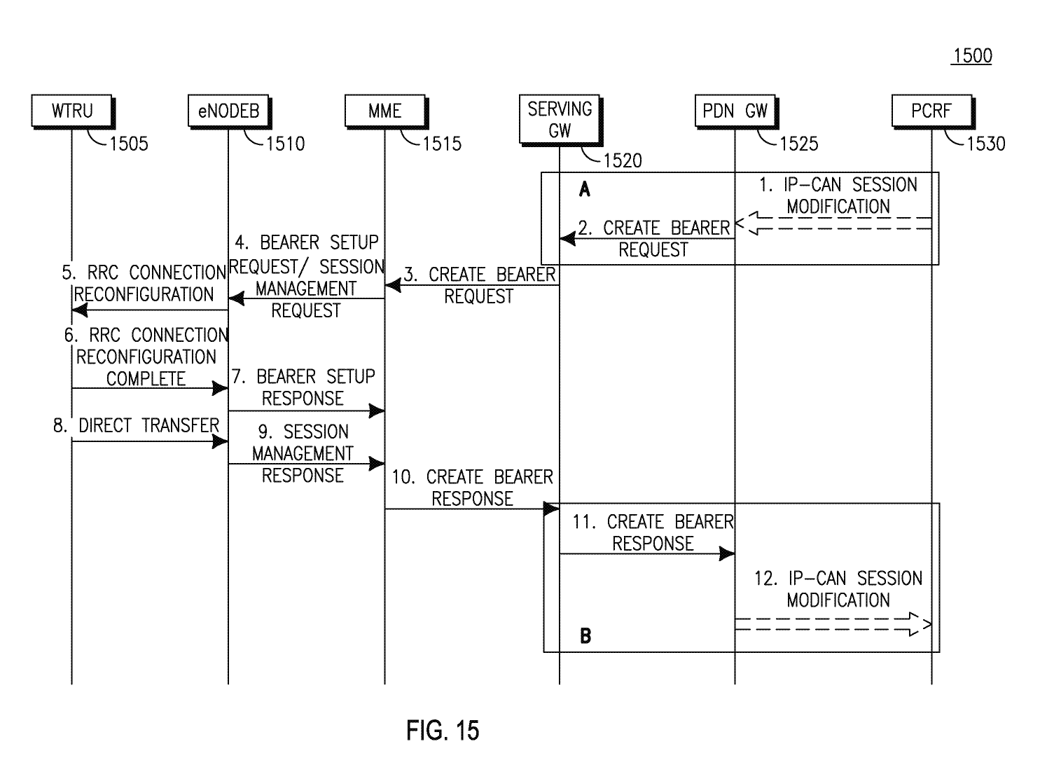

FIG. 15 is an example signal flow diagram 1500 for a network initiated dedicated bearer activation procedure. The signaling may flow between WTRU 1505, eNB 1510, MME 1515, serving GW (SGW) 1520, PGW 1525 and a Policy and Charging Rules Function (PCRF) 1530. The PCRF 1530 may send an IP Connectivity Access Network (IP-CAN) session modification request to the PGW 1525 (1), which in turn may send a create bearer request to the SGW 1520 (2). The SGW 1520 may forward the create bearer request to the MME 1515 (3), which in turn may forward the create bearer request and session management request to the eNB 1510 (4). The eNB 1510 may transmit a radio resource controller (RRC) connection reconfiguration message to the WTRU 1505 (5), which may transmit a RRC connection reconfiguration complete message back to the eNB 1510 (6). A bearer response message may be sent by eNB 1510 to the MME 1515 (7). The WTRU 1505 may transmit a direct transfer message to the eNB 1510 (8). Upon receipt of both the RRC connection reconfiguration complete message and the direct transfer message, the eNB may send a session management response message to the MME 1515 (9), which in turn may send a create bearer response to the SGW 1520 (10). The PGW 1525 may receive the create bearer response from the SGW 1520 (11) and may send an IP-CAN session modification response to the PCRF 1530. The signal flow 1500 involves the PGW 1525 and the SGW 1520 to setup resources for the corresponding bearers, (assuming non-LIPA PDN connection). However since LIPA traffic goes via a direct path from the HeNB to the LGW, there will not be a need to setup resources between the SGW 1520 and the LGW.

In addition, a user with a LIPA PDN connection might only want to have user/WTRU-initiated sessions with IP devices in the local network. Thus, the establishment of a LIPA PDN connection might, due to location based services, result in some IP devices to initiate mobile terminated (MT) sessions for a WTRU in question. Since the WTRU might be in a roaming scenario where the user might be charged for a session, there would be a need for mechanisms that prevent MT sessions that are not accepted by the user. Described herein below are methods that allow the user to allow the sessions that he/she wants and not have any device randomly initiate MT sessions with the WTRU/user.

In the current architecture, the LGW is not connected to the PCRF, which is involved in the charging for a LIPA PDN connection and dedicated bearers that might be setup for the LIPA PDN connection. Described herein are methods for charging if LIPA PDN connections or SIPTO@LN allow dedicated bearers to be setup.

Other issues addressed herein relate to LGW node failure, CN node failure, and failure impact on the network, where the WTRU has an active LIPA PDN connection.

Methods addressing issues with respect to identification or information elements (IEs) that may be needed for LIPA/SIPTO@LN operations are described herein below. For example, such identification or information elements (IEs) may be missing or not provided, or might already be in use in an HeNB when a new request is received for another LIPA data path but with a same correlation ID.

Other optimizations may be needed to effectively support LIPA mobility. One such optimization may be an enhancement to the current paging procedure. Currently the LGW may send the first packet to the SGW; the SGW may then ask the MME to page the WTRU. Once the WTRU is in connected mode, the SGW may send the first packet to the WTRU, and then the LGW may send the rest of the buffered data.

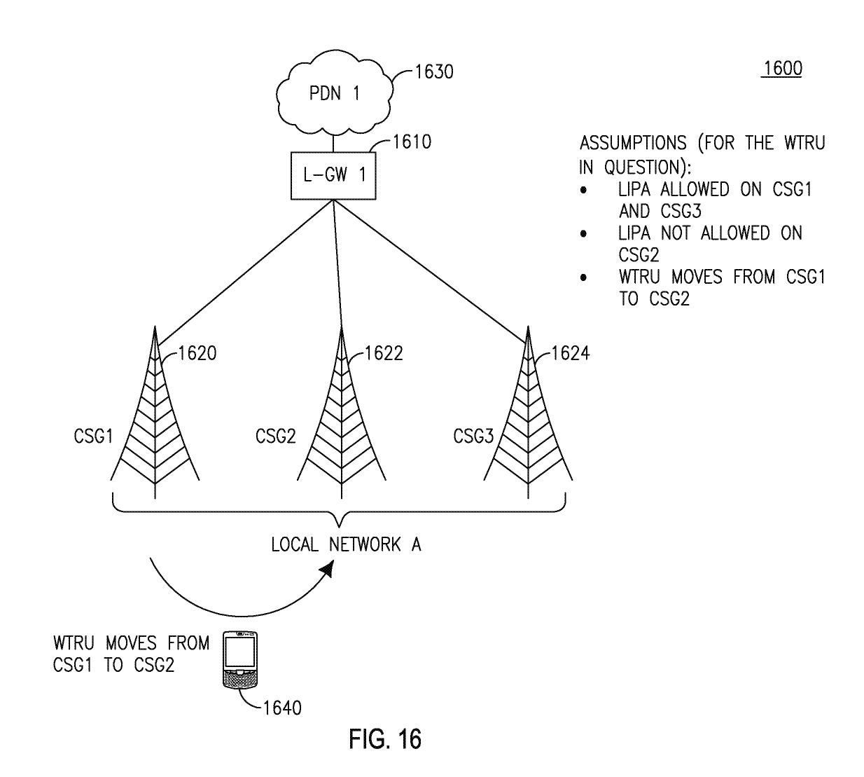

FIG. 16 shows an example system 1600, where a WTRU 1605 may be roaming from one CSG to another. The system 1600 may include a LGW1 1610 in communication with CSG1 1620, CSG2 1622 and CSG3 1624. A PDN1 1630 is also in communication with the LGW1 1610. LIPA may be supported in CSG1 1620 and CSG3 1624 but not in CSG2 1622.

LIPA is supported for Access Point Names (APNs) that are valid only when the WTRU is connected to a specific CSG. For example, CSG1 1620 and CSG3 1624 in FIG. 16. When a WTRU is under the coverage of a CSG that is part of a local network, the subscription for this WTRU may be such that LIPA is not allowed for the serving CSG, (i.e., the CSG providing coverage to the WTRU). For example, CSG2 1622. Therefore, in addition to considering whether a CSG may be part of a local network, a MME or other network entity may need to determine if the user's subscription allows LIPA to be provided from the CSG in question. This may then be used to decide if a session is continued as LIPA or MRA as the WTRU moves within the coverage of a local network. For example, as WTRU 1640 moves from CSG1 1620 to CSG2 1622, the session may be continued as a MRA session since CSG2 1622 lacks LIPA. question Thus, when the WTRU 1640 moves from CSG1 1620 to CSG2 1622, the subscription is such that LIPA may not be allowed for the user in CSG2 1622 even though CSG2 1622 connects to the local network supported by LGW1 1610.

Described herein are example methods that may fall under several system areas, for example, system access and mobility management, or mobility management and handover. To this end, the methods described herein below, even though grouped under these system areas, should not be limited to the system areas under which they are grouped. Moreover, the grouping is not intended to limit the applicability of the methods to a particular problem/system area. Thus, the methods are applicable to several system areas/procedures, (i.e., RRC, non-access stratum (NAS), or any other combination or layer), and may also be applied in combination with any other method under any other system area.

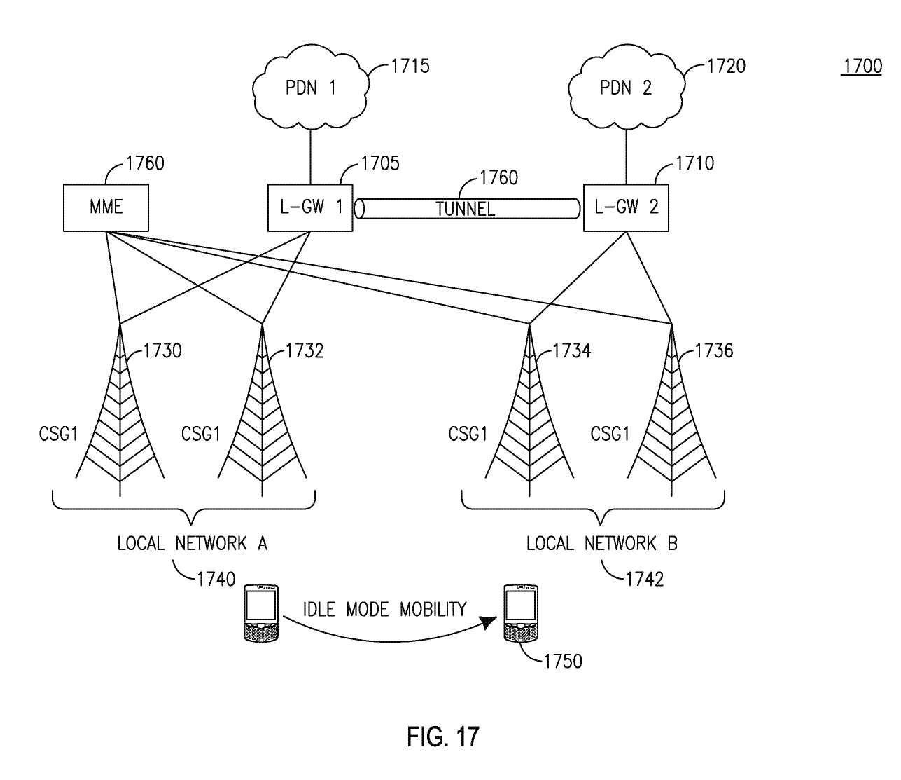

Described herein are example methods for deactivation of a LIPA PDN connection. One example method addresses the deactivation of a LIPA PDN connection during idle mode mobility. FIG. 17 shows an example scenario 1700 of idle mode mobility. The scenario 1700 illustrates a LGW1 1705 and a LGW2 1710. The LGW1 1705 may communicate with PDN1 1715 and PDN2 1720 and LGW2 1710 may communicate with PDN2 1720. HeNBs 1730 and 1732 may communicate with the LGW1 1705, which together may constitute local network A (LN A) 1740. HeNBs 1734 and 1736 may communicate with the LGW2 1710, which together may constitute local network B (LN B) 1742. Each of the HeNBs also communicates with a MME 1760. A WTRU 1750 may start in LN A 1740 and have a LIPA PDN connection to PDN1 1715. While in idle mode, the WTRU 1750 may move to the HeNBs 1734 and 1736 in LN B 1742, and may send a NAS message to the network. The NAS message may be a TAU, Service Request, and the like.

The core network may perform the following to determine whether the LIPA PDN connection should be maintained or deactivated for the WTRU, where the core network may refer to a number of network entities including, but not limited to, a MME, SGSN, PGW, and the like. For example, the MME 1760 may use a provided LGW address for LGW 2 1710 by the HeNB in the LN B 1742, or any other information that identifies the LN to which the serving HeNB belongs to. This may, for example, be a LN ID. This information may be used to verify whether service continuity for LIPA and/or SIPTO@LN may be achieved for the WTRU in question.

The possibility of having service continuity may be based on all or a subset of the following criteria which may be checked by the MME. An example criteria that may be checked is whether LIPA is allowed in a target cell for the WTRU and for the required APN.

Another criteria that the MME may verify is whether there is an actual connection between the LGW1 1705 and LGW2 1710 such that data for LIPA or SIPTO@LN may be routed to the WTRU's 1750 current location/HeNB. For example, the connection may be tunnel 1760. Note that a connection between LGW1 1705 and LGW2 1710 is only an example of how service continuity may be achieved. Another method to achieve service continuity is to route the traffic from the LGW to the SGW and then to the HeNB that is serving the WTRU. Thus, in general, it should be verified by the MME if such a connection may be possible. This may be done on a per WTRU basis, (based on a subscription basis to allow this for one WTRU versus another). In addition, the MME may be configured with the necessary information. For example, the LGWs may communicate to the MME whether or not each LGW connects to another LGW. This may be done upon a first signaling exchange between the MME and the LGWs.

Alternatively, the MME may be provided with this information in an implementation specific manner, or the MME may request the LGWs to provide information about the existence of a connection to other LGWs. For example, in the mobility scenario depicted above, the MME may, (after receiving a NAS message from the WTRU 1750 in LN B 1742), check LGW1 1705, (via LGW address or identity), with which the WTRU 1750 had a PDN connection for LIPA and/or SIPTO@LN. The MME may contact the LGW1 1705 to verify whether there is a connection to LGW2 1710.

Alternatively, the MME may verify with the LGW under the other LN, (i.e., LGW2 1710 under LN B 1742), whether it connects with the LGW1 1705 that has the WTRU's 1750 PDN connection for LIPA and/or SIPTO@LN. This verification may be done via an existing message or a new message that may be defined for use between the MME and the LGW. This may occur via the SGW, i.e., the MME requests the SGW to perform this verification which in turn contacts the LGW as proposed above.

The MME may also check whether service continuity, (LIPA and/or SIPTO@LN), may be allowed for the WTRU in question. In other words, there may be an actual connection between LGW1 1705 and LGW2 1710 via tunnel 1760 but the WTRU's 1750 subscription is such that LIPA service continuity and/or SIPTO@LN is not allowed, (regardless of the means of achieving this service continuity, i.e. via a tunnel or any other method).

In addition, even if the previous conditions are met and service continuity for LIPA and/or SIPTO@LN is allowed and may be done, the user may be charged more due to the service continuity feature. Thus, the MME might request the user's/WTRU's consent to allow such service continuity. This may be done on a per need basis, (i.e., real-time), or may be done based on WTRU/user provided configurations for this service ahead of time, (during attach or any other procedure), or it may be provided to the network via Home Subscriber Server (HSS), or any other node. If the network, (for example, MME, SGSN, and the like), decides that service continuity for LIPA and/or SIPTO@LN may not be provided, then the MME/SGSN may deactivate the LIPA PDN connection. On the other hand, if the MME, (based on, but not limited to, the criteria defined above), decides that service continuity may be achieved then the MME does not deactivate the LIPA PDN connection for the WTRU.

Described herein is enabling service continuity for LIPA and/or SIPTO@LN when a WTRU moves out of the coverage of local network. For example, the WTRU may move to another LN with HeNBs that do not directly connect to the LGW with which the WTRU has established a PDN connection for LIPA and/or SIPTO@LN.

Rules may be defined for a WTRU's/user's service continuity, i.e., in the subscription profile, based on the user's subscription and/or network policy. The network may allow LIPA service continuity only, SIPTO@LN service continuity only, or both, whenever the WTRU is not in the coverage of the LN where such PDN connection was established. The WTRU may be in a macro cell or in the coverage of other LN/HeNBs that do not connect to the LGW with which the WTRU has the LIPA and/or SIPTO@LN PDN connection.

Described herein is handover before completion of a NAS procedure. In this scenario, the WTRU is in connected mode to perform a NAS procedure, (for example a TAU/RAU procedure), and is then handed over to another cell before the completion of the NAS procedure. For example, referring to FIG. 17, the WTRU 1750 may have initiated a TAU procedure with the MME (not shown), and before the MME responds with a TAU Accept message, the WTRU 1750 is handed over to another cell, for example, HeNB 1734 in LN B 1742. Even though there might be service continuity for LIPA or SIPTO@LN, a particular WTRU's subscription might indicate that service continuity is not allowed for the WTRU in question.

Typically, the WTRU may initiate a NAS procedure in idle mode due to expiry of the periodic update timer. The TAU message may be sent by the WTRU to the HeNB, which in turn may send it to the MME using an SlAP message referred to as INITIAL WTRU MESSAGE. Furthermore, the response typically may be sent by the MME to the HeNB using the DOWNLINK NAS TRANSPORT message, which does not contain any information, (correlation ID for example), about whether or not the WTRU has a LIPA PDN connection. Thus, before the TAU Accept message may be sent to the WTRU, the HeNB may perform handover for the WTRU to another HeNB where the WTRU may or may not be allowed to continue its LIPA or SIPTO@LN service. Although the scenario described herein may use LTE system terminology, the same problem exists for UTRAN, and the following methods may be applicable to at least LTE and UTRAN, and may be used in any combination.

In an example method, the S1AP message, WTRU CONTEXT MODIFICATION REQUEST, (and the equivalent RANAP message), may also include the correlation ID or any other indication to signal to the HeNB that the WTRU in question has a LIPA PDN connection (or SIPTO@LN). With this indication, the HeNB may not perform subsequent handovers until the NAS procedure is completed. For example, the handover may be performed after the DOWNLINK NAS TRANSPORT message is received at the HeNB for the WTRU in question.

In another example method, a response message for the DOWNLINK NAS TRANSPORT may be used by the HeNB to inform the MME about an ongoing handover procedure for a WTRU in question. For example, a new message such as a DOWNLINK NAS TRANSPORT ABORT (or any other message) may be sent by the HeNB in response to the DOWNLINK NAS TRANSPORT when the HeNB is preparing or executing a handover procedure for the WTRU in question. The message may also have a cause code to indicate the reason for aborting the DOWNLINK NAS TRANSPORT message at the HeNB. This may be, for example, a S1/X2/Sxx handover in progress, where Sxx may be a new interface in SA2 for connecting an HeNB to a LGW. Thus, with this indication, the MME may wait for the handover to terminate, (by receiving an indication from the target HeNB/macro cell that the WTRU has been handed over to), and then respond to the NAS message that was originally sent by the WTRU.

Moreover, the MME may take into account the new location of the WTRU in terms of LIPA/SIPTO@LN service continuity, (i.e., whether or not the target cell connects to the LGW or if LIPA/SIPTO@LN service continuity is available at the WTRU's new location as described earlier), before sending the NAS message. Thus, even though MME might have sent a TAU Accept to the source HeNB, (which may respond with an abort as described herein above), the MME may take the new WTRU location into account and cause a TAU Reject to be sent to the WTRU instead. For example, a reject message may be sent if the WTRU only had one PDN connection which is for LIPA and service continuity for LIPA is not allowed or cannot be achieved in the target cell. The MME may still send a TAU Accept message towards the target cell, but the MME may also modify the contents of this message to signal to the WTRU that certain bearers have been deactivated in the MME by using the EPS bearer status information element (IE).

Described herein are network initiated session management procedures. In an example method, the WTRU's subscription may indicate if there are limitations to the number of dedicated bearers that may be established for a LIPA PDN connection, and if yes, then what that limit may be. Moreover, the limit may be just a certain number of dedicated bearers, and in addition, there may be a maximum bit rate that is allowed for all the bearers within the LIPA PDN connection, (or SIPTO@LN). Moreover, the network may reject any session management requests, (activation of dedicated EPS bearers or packet data protocol (PDP) contexts, for example), that may cause the quality of service (QoS)/bit rate limit to be exceeded. A new or an existing cause code may be used by the network to indicate the reason for rejecting such requests. For example, a “maximum number of dedicated bearers reached” may be used for the cause code. Upon reception, the WTRU may not request activation of dedicated bearers until an explicit indication from the network to do so, (network initiated requests), or until the WTRU deactivates some of its existing bearers for the given PDN connection. The maximum number of permitted bearers that may be activated by a WTRU for LIPA/SIPTO@LN may also be signaled to the WTRU during any NAS procedure including for example, upon attach, upon a PDN connectivity request procedure, or any other NAS message.

In a network initiated EPS bearer activation method, the LGW may include an indication that the request is for a LIPA and/or SIPTO@LN. This may be included by the LGW in a Create Session Request message that is sent to the SGW. When the SGW receives this message, the SGW may not create S5 bearers for this request based on the indication provided since the data path will be directly between the HeNB and the LGW. Thus, the SGW may simply forward the message to the MME. The MME may then verify whether this request may be accepted based on subscription information, for example, maximum number of dedicated bearers, maximum bit rate for this LIPA and/or SIPTO@LN connection, or any other condition. If this is accepted by the MME, then the MME may send the appropriate S1AP message. This may be, for example, a EUTRAN Radio access bearer (E-RAB) Setup Request message and may include an indication that the bearer is for a LIPA and/or SIPTO@LN session. The indication may be, for example, a correlation ID. Moreover, such an indication may be different for LIPA and SIPTO@LN sessions. An explicit indication may be used for both types of services, and may be a ‘LIPA bearer’ or ‘SIPTO@LN’ indicator.

The MME may store the correlation IDs or any other identification that may be used for LIPA and/or SIPTO@LN on a per WTRU basis. Thus, the MME may verify the assignment of new identifications. For example the MME may verify new correlation IDs for a given bearer within a LIPA and/or SIPTO@LN PDN connection, and may reject any request that uses a conflicting correlation ID for the same PDN connection. The MME may return a reject cause code to indicate that the reason is a conflicting correlation ID. Furthermore, the MME may propose a new value that should be used by the LGW/SGW. This rejection may also be performed by the HeNB. For example, the HeNB may reject an E-RAB Setup Request message with the cause “existing correlation ID” and send the rejection to the MME. The MME may notify the LGW/SGW or send a reject message with the same cause. Similarly, the HeNB may propose a new value that may be forwarded to the LGW.

In another example, rules may be implemented such that the user/WTRU may allow certain sessions for LIPA and/or SIPTO@LN sessions but not others. For example, the following rules may be defined, all of which may be in the user subscription profile at the HSS/MME/SGSN, locally at the WTRU stored in settings or provided via Open Mobile Alliance Device Management (OMADM), over the air (OTA), Access Network Discovery and Selection Function (ANDSF), and the like. Moreover, these rules may be enforced during initial system access, during the establishment of a LIPA and/or SIPTO@LN PDN connection, or on a per request basis, (during activation of bearers or PDP contexts for LIPA and/or SIPTO@LN). In addition, these rules may be enforced by the LGW, the MME/SGW/SGSN, or the WTRU, in any combination. The MME/SGSN may get these rules from the HSS and provide them to the SGW and L-GW.

In an example, mobile originated (MO) sessions for LIPA and/or SIPTO@LN are allowed. In this example, some mobile terminated (MT) requests for LIPA and/or SIPTO@LN may be rejected. As indicated earlier, this rule may be enforced at the LGW, the MME, or the WTRU. Thus the LGW may locally reject any request from an IP device that would otherwise trigger a MT session setup or data flow. This may be based on a flag or indication that is saved locally at the LGW. Alternatively, the MME/SGW may reject such requests made from the LGW for a network initiated/MT request. This may also be based on local settings/flags/indications at these nodes.

The WTRU may also reject MT requests if the WTRU's setting is such that no MT requests for LIPA and/or SIPTO@LN should be accepted. The decision to reject a MT session may be based on other conditions that may be defined in the WTRU or network. Also, the rejection of a MT session/request for LIPA and/or SIPTO@LN connection may be based on the user's input. The user may be requested to accept or reject any MT session for LIPA and/or SIPTO@LN. This may be done at start up, at the establishment of the PDN connection for LIPA and/or SIPTO@LN, or on a per request basis such as the network initiated dedicated bearer request procedure. Thus, the network may include an IE in such messages, (or any NAS message), to request the user to accept or reject the MT LIPA and/or SIPTO@LN session. The WTRU may display this option to the user and based on the response, the WTRU may send an accept, (i.e., accept the NAS session management message—if the user accepts the MT session or if the user doesn't respond after some time), or a reject message, (i.e., reject the NAS session management message—if the user rejects the MT session or if the user doesn't respond after some time), to indicate the user's/WTRU's choice. Thus, if the WTRU/user accepted the MT request, then the network, (e.g. MME/SGSN), may continue with the procedure as usual. Otherwise, the network aborts the procedure with appropriate cause codes to the necessary processing nodes, (SGW or LGW).

Alternatively, there may be rules that only MT sessions are allowed. In this example, the LGW/MME/SGW is trusted and is given the responsibility to allow MT calls. Once an MT call is initiated, the WTRU has to accept it. In addition, the WTRU may be configured, (via part of saved settings, OMA DM, OTA, or any NAS/RRC message), to not initiate some or any MO requests, (activation of dedicated bearers, for example), for a LIPA and/or SIPTO@LN PDN connection. Thus, if this is the policy for a given WTRU, the MME/SGW/SGSN/LGW may reject MO requests based on the same policy that these nodes have been provided with. As described herein, the nodes may get the policies from the HSS and also may forward the policies between them.

The rules above may be applied in any combination and may also be applied in both the home public land mobile network (HPLMN) and/or the visited PLMN (VPLMN). Moreover, the VPLMN may contact the HPLMN to get any of the proposed policies/rules for LIPA and/or SIPTO@LN. If this is not possible, the VPLMN may apply its own policies accordingly, (i.e. the core network (CN) nodes of the VPLMN would apply the local network/operator policies).

Described herein are example methods for LIPA and/or SIPTO@LN and IMS emergency calls. The example methods may be applicable when there is a LIPA and/or SIPTO@LN PDN connection and an existing emergency call (IMS emergency call or CS emergency call). In an example method, LIPA and/or SIPTO@LN sessions/bearers/PDN connections may be dropped when there is an ongoing emergency call or when there is a request to place an emergency call. Alternatively, the WTRU's LIPA and/or SIPTO@LN connections (or bearers) are only dropped during handover, (i.e., the source HeNB may not include these bearers for handover).

In another example, the traffic may be routed via the SGW such that it appears to be non-LIPA and/or non-SIPTO@LN traffic and thus the conditions for LIPA and/or SIPTO@LN handover are not needed to be met. Upon the request for an emergency call, the MME/SGSN may inform the LGW to start forwarding the data via a different path, (i.e., S5 or Gn for LTE or UTRAN, respectively), and therefore not directly via the HeNB. Moreover, the HeNB may be informed to change the data forwarding path for the corresponding bearers such that they now go via the SGW/HeNB instead of directly to the LGW. This may be done using an existing or new message over the S1AP/RANAP interface or any interface that may be used between the CN nodes and the RAN.

Described herein are example methods for paging optimization for LIPA PDN connections. The network may optimize the paging function, i.e. instead of sending the page message to all the cells under the MME, the page may be contained to the local home network (LHN), (or generally the LN). More precisely, the WTRU might be paged only in the cell where it is camped on. This optimization may be achieved by extending the concept of proximity indication to the LHN with LIPA PDN. The WTRU may send the proximity indication or some other indication message, (a TAU or routing area update (RAU) for example), while in idle mode to inform the HeNB and the LGW that it is moving out of the coverage of LIPA (SIPTO) area. If the MME does not receive such an indication, it will assume that the WTRU is still under the coverage of the LGW and may only page the WTRU in the coverage area of the HeNBs under that particular LGW. This may also be applied for inbound mobility. When the WTRU enters the LIPA (SIPTO) coverage area, it may send a similar indication to the network. As a result, the network may only page the WTRU in that LHN.

Another example optimization is to perform the paging without involving the CN. This may be achieved by having some paging functionality in the LGW. In this case, when the LGW receives user data in idle mode and it is sure that the WTRU is still in the LHN, (or it knows that the WTRU is still under LIPA coverage), it does not have to go through the SGW and MME to trigger the paging procedure. The LGW may directly send the paging message to HeNBs connected to it. The page reply from the WTRU may also be sent directly to the LGW bypassing all the CN nodes.

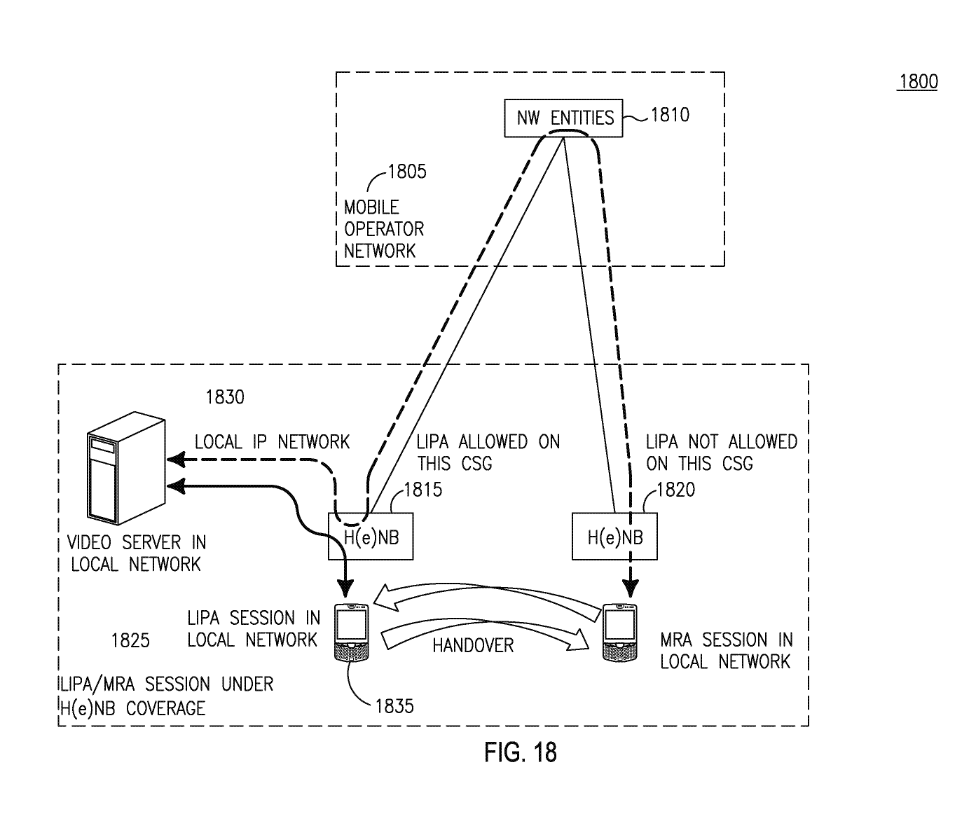

Described herein example methods for maintaining LIPA sessions as managed remote access (MRA) sessions within one local network. A LIPA session should be maintained as an MRA session when a WTRU moves, within the same local network, from one HeNB where LIPA is allowed, (as per subscription), to another HeNB where LIPA is not allowed, (as per subscription). An example scenario 1800 is shown in FIG. 18. A mobile operator core network 1805 may include network (NW) entities 1810 in communication with HeNB 1815 and HeNB 1820, which are part of the same local network 1825. The HeNB 1815 may allow LIPA sessions and HeNB 1820 may not allow LIPA sessions. The local network 1825 may have a video server 1830 connected to the local network 1825 to provide content.

A WTRU 1835 may have a LIPA session with HeNB 1815. When the WTRU 1835 is handed over to HeNB 18200, the LIPA session may not continue as HeNB 1820 may not support LIPA sessions due to, for example, subscription information. The LIPA session is not terminated but continued as an MRA session in HeNB 1820, (the target HeNB or cell). This method assumes that the WTRU 1835 may have a subscription to MRA services that are allowed in the target HeNB.

Conversely, if a WTRU starts a connection to a local PDN in an HeNB that is part of the local network but is not allowed to provide LIPA, then the WTRU may start an MRA session. If the WTRU is then handed over to another HeNB within the same local network and LIPA is allowed for this WTRU, (as per subscription information), then the MRA session may continue as a LIPA session in the target HeNB.

The above may also be applicable if a WTRU starts as an MRA session in any cell, (NB, eNB, HeNB of a different local network, HeNB that does not belong to any local network, or any inter-RAT base station) and then hands off to an HeNB that is part of a local network but the subscription information is such that a LIPA session may not be allowed on the target HeNB or closed subscriber group (CSG). Thus, an MRA session may be handed over and still be maintained as an MRA session even if the source HeNB is part of a local network.

Alternatively, when a WTRU starts as an MRA session in any HeNB within a given local network and then hands off to an HeNB in the same local network, the subscription information may not allow a LIPA session on the target HeNB or CSG. The operator may choose to configure the MRA permission in a CSG to match the corresponding LIPA permission for the same CSG, such that if there is no LIPA subscription in the target CSG, the WTRU will not be allowed to use MRA services in that CSG either. In this case, when the WTRU hands over to the target CSG cell in the same local network, the LIPA PDN connection may be deactivated and may not continue as an MRA session. The association of MRA and LIPA permission may be done for any CSG regardless of whether or not the target eNB/HeNB is part of the same local network or another local network

The methods described herein apply equally to LTE, 3G and other systems that use similar concepts, for example, GERAN. As mentioned above, the MRA session might only be possible if the network, (for example, the MME, source cell, target cell, or any other network component or combination of components), verifies that MRA is allowed in the target cell, in the target cell given the WTRU comes from a particular source cell, or any combination. In the second case, this means that if at the source cell the WTRU had MRA, (even if the source was a CSG), then at the target cell the WTRU may continue its session as MRA. In other words, MRA continuation does not imply the WTRU has to come from a source cell that is part of the macro.

All of the above procedures may be applicable to LTE systems, 3G systems and any other system with similar functionality. Moreover, even though the signaling messages and examples used are in the context of LTE, the same may be applicable to other systems using similar messages. Even though the procedures described herein are explained for LIPA, the same procedures may be applicable to SIPTO at the local network. All the embodiments described herein are equally applicable to 3G, LTE systems and any other wireless systems.

Although features and elements are described above in particular combinations, one of ordinary skill in the art will appreciate that each feature or element may be used alone or in combination with any of the other features and elements. In addition, the embodiments described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, a cache memory, a semiconductor memory device, a magnetic media, (e.g., an internal hard disc or a removable disc), a magneto-optical media, and an optical media such as a compact disc (CD) or a digital versatile disc (DVD). A processor in association with software may be used to implement a radio frequency transceiver for use in a WTRU, UE, terminal, base station, Node-B, eNB, HNB, HeNB, AP, RNC, wireless router or any host computer.

What is claimed:

1. A method, implemented at a network node, for handling a local IP access (LIPA) packet data network (PDN) connection, the method comprising:
receiving a non-access stratum (NAS) request message from a wireless transmit/receive unit (WTRU);
determining service continuity based on existence of a connection between a source local gateway (LGW) and a target LGW;
deactivating the LIPA PDN connection on a condition that the connection lacks between the source LGW and the target LGW; and
maintaining the LIPA PDN connection on a condition the connection exists between the source LGW and target LGW.

2. The method of claim 1, wherein rules for service continuity are maintained by at least one of the network node or in a WTRU subscription profile.

3. The method of claim 2, wherein the rules indicate that one of mobile originated (MO) sessions or mobile terminated (MT) sessions are disallowed.

4. The method of claim 1, wherein the network node receives information about the connection between the source LGW and the target LGW from at least one of the source LGW and the target LGW.

5. The method of claim 1, further comprising:
transmitting a message in response to the NAS request message that includes an indication that the WTRU is connected through the LIPA PDN connection.

6. The method of claim 5, wherein the indication prevents a handover of the WTRU to another cell until the NAS procedure is complete.

7. The method of claim 1, further comprising:
receiving an abort message on a condition that a handover is in progress.

8. The method of claim 1, wherein a subscription profile of the WTRU indicates limitations to a number of dedicated bearers available for the LIPA PDN connection.

9. The method of claim 1, further comprising:
receiving a create session request message including an indication that the request is for the LIPA PDN connection, wherein the indication may be used by another network node to avoid establishing certain bearers.

10. The method of claim 1, further comprising:
sending a user prompt to reject or accept a session.

11. The method of claim 1, further comprising:
dropping the LIPA PDN connection for one of receiving a request for an emergency call or there is an ongoing emergency call.

12. The method of claim 1, further comprising:
changing a path of the LIPA PDN connection for one of receiving a request for an emergency call or there is an ongoing emergency call.

13. The method of claim 1, further comprising:
sending a paging message to a cell associated with the LIPA PDN connection.

14. The method of claim 13, wherein mobility information is received from the WTRU with respect to a local network.

15. A method, implemented at a wireless transmit/receive unit (WTRU), for handling a local IP access (LIPA) packet data network (PDN) connection, the method comprising:
transmitting a non-access stratum (NAS) request message to a network node,
wherein the LIPA PDN connection is deactivated on a condition that a connection lacks between a source local gateway (LGW) and a target LGW, and
wherein the LIPA PDN connection is maintained on a condition the connection exists between the source LGW and target LGW.

16. The method of claim 15, further comprising:
transmitting mobility information with respect to a local network to the network node for paging optimization.

17. A network node for handling a local IP access (LIPA) packet data network (PDN) connection, comprising:
the network node configured to receive a non-access stratum (NAS) request message from a wireless transmit/receive unit (WTRU);
the network node configured to determine service continuity based on existence of a connection between a source local gateway (LGW) and a target LGW;
the network node configured to deactivate the LIPA PDN connection on a condition that the connection lacks between the source LGW and the target LGW; and
the network node configured to maintain the LIPA PDN connection on a condition the connection exists between the source LGW and target LGW.

18. The network node of claim 17, wherein the network node is further configured to receive information about the connection between the source LGW and the target LGW from at least one of the source LGW and the target LGW.

19. The network node of claim 17, further comprising:
the network node further configured to transmit a message in response to the NAS request message that includes an indication that the WTRU is connected through the LIPA PDN connection.

20. The network node of claim 17, further comprising:
the network node further configured to receive an abort message on a condition that a handover is in progress.
